(19) United States
(12) Patent Application Publication
(10) Pub. No.: US 2006/0149018 A1
(43) Pub. Date: Jul. 6, 2006

(54) Transparent molded article

(75) Inventor: Yoshitaka Kitahara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOYA CORPORATION, Tokyo (JP)

(21) Appl. No.: 11/296,526

(22) Filed: Dec. 8, 2005

Related U.S. Application Data
(63) Continuation of application No. PCT/JP04/08381, filed on Jun. 9, 2004.

(30) Foreign Application Priority Data
Jun. 9, 2003 (JP) 163144/2003
Jul. 25, 2003 (JP) 279777/2003

(51) Int. Cl. C08G 18/00

(52) U.S. Cl. 528/44

(57) ABSTRACT

Provided are a transparent molded article comprised of polythiourethane obtained by polymerizing monomer components comprising the following component (A) and component (131) and a transparent molded article obtained by polymerizing monomer components comprising the following component (A), component (B1), component (B2) and component (C). Component (A): One or More Polythiol Compound Denoted by General Formula (I)
General Formula (I) 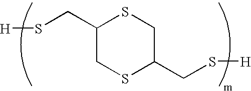 (In general formula (I), m is 1, 2, 3, 4, 5 or 6.) Component (B1): One or More Polyisocyanate Compound Denoted by General Formula (II)
General Formula (II) 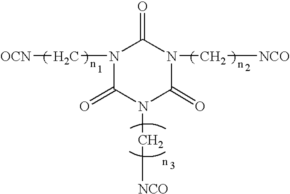
(In general formula (II), n₁, n₂ and n₃ are each independently 3, 4, 5, 6, 7 or 8.) Component (B2): One or More Aliphatic Dilsocyanate Compound Having an Intramolecular Cyclic Stucture Component (C): aliphatic diol compound

### CROSS-REFERENCE TO RELATED APPLICATIONS

The present application claims priority under 35 U.S.C. §119 to Japanese Patent Applications No. 2003-163144 filed on Jun. 9, 2003 and No. 2003-279777 filed on Jul. 25, 2003. The present application is a continuation of PCT/JP2004/008381 which was filed on Jun. 9, 2004.

### BACKGROUND OF THE INVENTION

1. Field of the Invention

The present invention relates to a molded article suitable for optical application, which has a high refractive index, low dispersion and excellent transparency as well as is excellent in impact resistance and weatherability. In more detail, the present invention relates to a transparent molded article which has excellent optical characteristics such as a high refractive index and high Abbé number, is excellent in impact resistance and can be suitably employed as various lenses such as eyeglass lenses, a prism, optical fiber, a substrate for recording media and a filter.

2. Discussion of the Background

Since plastic is lighter, tends to crack less, and dyes more readily than glass, it has been employed in optical applications such as various lenses in recent years. Plastic materials generally employed in optics include polyethylene glycol bisallyl carbonate (CR-39) and polymethyl methacrylate (PMMA). However, since these plastic materials have a refractive index of less than or equal to 1.5, when employed as lens materials, for example, the lens becomes thicker with the level of magnification. Not only does the lightweight advantage of plastic end up being lost, but thick plastic is undesirable from an esthetic point of view. Further, when these plastic materials are employed in concave lenses, there are disadvantages in that the thickness of the lens perimeter (edge) increases, tending to result in birefringence and chromatic aberration.

Accordingly, plastic materials of high refractive index have been developed utilizing the characteristics of plastic of low specific gravity to permit the thinning of lenses. Examples of such materials are polythiourethanes obtained from pentacrythritoltetraais(mercaptopropionate) and diisocyanate compounds, and polythiourethanes obtained from 4-mercaptomethyl-1,8-dimercapto-3,6-dithiaoctane and diisocyanate compounds (see Japanese Unexamined Patent Publications (KOKAI) Showa No. 63-46213 (“Reference 1” hereinafter) and Heisei 2-270859 (“Reference 2” hereinafter)).

However, although the polythiourethanes described in References 1 and 2 have high refractive indexes, there are problems with weatherability, heat resistance, and the like.

By contrast, the present inventors conducted extensive research into solving these problems, resulting in the discovery that polythiourethane obtained by reacting 2,5-dimercaptomethyl-1,4-dithiane, oligomers thereof, and polyisocyanate affords not just a high refractive index, but also greatly improved weatherability and heat resistance, which had previously been problematic (see Japanese Unexamined Patent Publications (KOKAI) Heisei 3-236386 (“Reference 3” hereinafter) and Heisei 11-202101 (“Reference 4” hereinafter)). Compared to the polythiourethanes described in References 1 and 2, the polythiourethanes described in References 3 and 4 have better impact resistance without substantial problems with practical use. However, in the optical materials employed in items such as eyeglasses, a need for materials having even higher impact resistance has developed.

It is a first object of the present invention to provide a molded article suitable for optical applications, that has high impact resistance, excellent transparency and a high refractive index.

It is a second object of the present invention to provide a transparent molded article suitable for optical applications, that has a refractive index and transparency equal to or higher than those of molded articles conventionally employed in optical materials such as lenses as well as has higher impact strength than that of molded articles conventionally employed in optical materials such as lenses.

### SUMMARY OF THE INVENTION

The present inventors conducted extensive research into achieving the above first object, resulting in the discovery that the above object can be achieved by a transparent molded article comprised of polythiourethane obtained by polymerizing a polythiol compound having a specific structure and a polyisocyanate compound having a specific structure. The present invention was devised on that basis.

That is, means for achieving the first object of the present invention are as follows;

(1) A transparent molded article comprised of polythiourethane obtained by polymerizing monomer components comprising the following component (A) and component (B1).

Component (A): one or more polythiol compound denoted by general formula (I)

General formula (I) 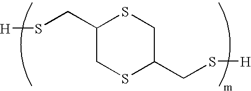
(In general formula (I), m is 1, 2, 3, 4, 5 or 6.)
Component (B1): one or more polyisocyanate compound denoted by general formula (II)

General formula (II) 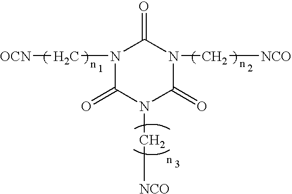
(In general formula (I), n₁, n₂ and n₃ are each independently 3, 4, 5, 6, 7 or 8.)
(2) The transparent molded article according to (1), wherein said monomer components further comprises the following component (B2).
Component (B2): one or more aliphatic diisocyanate compound having an intramolecular cyclic structure.
(3) The transparent molded article according to (2), wherein, in said polymerization, the ratio of NCO groups in component (B1) is greater than or equal to 25 mole percent of the total NCO groups comprised in component (B1) and component (B2).
(4) The transparent molded article according to (1), wherein, in general formula (I) of component (A), m is 1 or 2.
(5) The transparent molded article according to (1), wherein, in general formula (II) of component (B1), n₁, n₂ and n₃ are each independently 4, 5 or 6.
(6) The transparent molded article according to (1), wherein, in said polymerization, the molar ratio of isocyanate groups comprised in component (B1) and component (B2) relative to thiol groups comprised in component (A) ranges from 1.00 to 1.15.
(7) The transparent molded article according to (1), wherein the transparent molded article is a lens.
(8) The transparent molded article according to (7), wherein the lens is an eyeglass lens.

The present inventors conducted extensive research into achieving the above second object, resulting in the discovery that the above object can be achieved by a transparent molded article obtained by polymerizing a polythiol compound having a specific structure, an aliphatic diol compound, and a polyisocyanate compound having a specific structure. The present invention was devised on that basis.

That is, means for achieving the second object of the present invention are as follows;

(9) A transparent molded article obtained by polymerizing monomer components comprising the following component (A), component (B1), component (B2) and component (C).

Component (A): one or more polythiol compound denoted by general formula (I)

General formula (I) 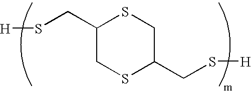
(In general formula (I), m is 1, 2, 3, 4, 5 or 6.)
Component (B1): one or more polyisocyanate compound denoted by general formula (II)

General formula (II) 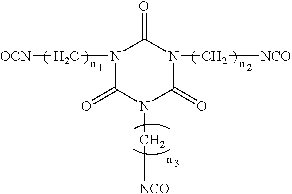
(In general formula (II), n₁, n₂ and n₃ are each independently 3, 4, 5, 6, 7 or 8.)
Component (B2): one or more aliphatic diisocyanate compound having an intramolecular cyclic structure
Component (C): aliphatic diol compound
(10) The transparent molded article according to (9), wherein, in said monomer components, the mass ratio of component (C) relative to total mass of component (A) and component (C) ranges from 3 to 60 percent.
(11) The transparent molded article according to (9), wherein, in said polymerization, the ratio of NCO groups in component (B1) ranges from 10 to 80 mole percent of the total NCO groups comprised in component (B1) and component (B2).
(12) The transparent molded article according to (9), wherein, in general formula (I) of component (A), m is 1 or 2.
(13) The transparent molded article according to (9), wherein said component (C) has a number average molecular weight ranging from 300 to 2000.
(14) The transparent molded article according to (13), wherein said component (C) has a number average molecular weight ranging from 600 to 1500.
(15) The transparent molded article according to (9), wherein the aliphatic diol compound of component (C) is polyetherdiol compound.
(16) The transparent molded article according to (15), wherein said polyetherdiol compound is polypropylene glycol.
(17) The transparent molded article according to (9), wherein, in general formula (II) of said component (B1), n₁, n₂ and n₃ are each independently 4, 5 or 6.
(18) The transparent molded article according to (9), wherein, in said polymerization, the molar ratio of isocyanate groups comprised in component (B1) and component (B2) relative to the total of thiol groups comprised in component (A) and hydroxyl groups comprised in component (C) ranges from 1.00 to 1.15.
(19) The transparent molded article according to (9), wherein the transparent molded article is a lens.
(20) The transparent molded article according to (19), wherein the lens is an eyeglass lens.

### DESCRIPTION OF THE EMBODIMENTS

The present invention will be described in more detail below.

The transparent molded article (referred to as “transparent molded article 1”, hereinafter) of the first aspect of the present invention is comprised of polythiourethane obtained by polymerizing monomer components comprising component (A) and component (B1).

The transparent molded article (referred to as “transparent molded article 2”, hereinafter) of the second aspect of the present invention is obtained by polymerizing monomer components comprising component (A), component (B1), component (B2) and component (C).

In the present invention, any molded article having transparency that does not impede its use as an optical material is covered under the term “transparent molded article.” There are many indexes of transparency employed for the various optical materials used in the transparent molded article of the present invention. Examples are light transmittance, the haze value, and visual inspection.

In some cases below, the “traisparent molded article” will be referred to simply as a “molded article”.

[First Aspect]

Transparent molded article 1 of the present invention is comprised of polythiourethane obtained by polymerizing monomer components comprising component (A) and component (B1).

Component (A), denoted by general formula (I) (wherein m is 1, 2, 3, 4, 5, or 6), is a polythiol compound with a 1,4-dithiane ring as its main skeleton. By incorporating this main skeleton, a high refractive index and a high Abbé number can be simultaneously imparted to the molded article obtained by polymerization without deteriorating weatherability. In general formula (I), so long as m is 6 or less, the viscosity of component (A) does not become excessively high, good handling properties can be maintained, and compatibility with other components is high. Thus, the optical transparency of molded articles obtained by polymerization can be increased. From the perspective of obtaining molded articles having a high refractive index, high Abbé number, and good optical transparency, m is desirably 1 or 2 in general formula (I). Further, component (A) may be a single compound in which m denotes an integer ranging from 1 to 6, or a mixture of two or more compounds with differing values of m.

Component (A) can be synthesized by known methods described in Japanese Unexamined Patent Publications (KOKAI) Heisei Nos. 3-236386 and 10-120676.

Component (B1), denoted by general formula (II) (wherein n₁, n₂, and n₃ are each independently 3, 4, 5, 6, 7 or 8), is a polyisocyanate compound having a structure in which an isocyanate group is bonded through an alkylene group having 3 to 8 carbon atoms to an isocyanurate ring. With this compound serving as one of its starting materials, transparent molded article 1 of the present invention possesses a suitably crosslinked structure that imparts heat resistance and impact resistance that are highly balanced, as well as having good solvent resistance.

In general formula (II), when at least one from among n₁, n₂, and n₃ denotes 2 or less, a molded article having good beat resistance can be obtained, but the impact resistance of the molded article obtained ends up being low. By contrast, when at least one from among n₁, n₂, and n₃ denotes 9 or more, a molded article having high impact resistance can be obtained, but the heat resistance of the molded article ends up being poor. In this manner, when n₁, n₂, and n₃ fall within the range of 3 to 8, in addition to a good balance being achieved between the heat resistance and impact resistance of the molded article obtained, good compatibility is maintained between component B1) and the other starting material components, which is desirable from the perspective of obtaining a molded article with good optical transparency. From the perspective of heat resistance, impact resistance and optical transparency, n₁, n₂, and n₃ are preferably 4, 5 or 6.

Component (B1) can be synthesized by known methods and is commercially available. Specific examples of component (B1) are tris(6-isocyanatohexyl)isocyanurate and tris(4-isocyanatobutyl)isocyanurate. These compounds can be synthesized by known methods. A product the main component of which is tris(6-isocyanatohexyl) isocyanurate is available under the trade name Coronate-HX from Nippon Polyurethane Industry Co., Ltd.

The monomer components comprising components (A) and (B1) may further comprise component (B2). Component (B2) is an aliphatic diisocyanate compound having one or more intramolecular cyclic structure. In this invention, the phrase “aliphatic diisocyanate compound having one or more intramolecular cyclic structure” means an aliphatic duisocyanate compound having a cyclic structure on the main chain or the side chain. The cyclic structure may be alicyclic, aromatic, or heterocyclic ring. In this invention, the term “alicyclic ring” means a cyclic hydrocarbon group not exhibiting aromatic properties and constituted with three or more carbon atoms, including compounds in which a portion of the methylene group making up the ring has been substituted with sulfir atoms or the like, such as a dithiane ring, or a bicyclo ring such as norbornene. The term “aromatic ring” means a cyclic hydrocarbon group exhibiting aromatic properties, including condensed rings such as naphthalene rings. The term “heterocyclic ring” means a ring, constituted with carbon atoms and different atoms such as oxygen or sulfur atoms, that exhibits aromatic properties. Compounds in which an isocyanate group is directly bonded to a ring exhibiting aromatic properties, such as the above “aromatic ring” and “heterocyclic ring,” are generally called aromatic isocyanate compounds. They do not correspond to aliphatic diisocyanate compounds having an intramolecular cyclic structure employed as component (B2) in the present invention. Accordingly, among the aliphatic diisocyanate compounds having a cyclic structure that are employed in the present invention, the aliphatic diisocyanate compounds with a cyclic structure that are “aromatic” or “eterocyclic” refer to compounds in which the isocyanate group is bonded to the ring through an alkylene group having one or more carbon atoms. In each of the alicyclic rings, aromatic rings, and heterocyclic rings given as examples of the above cyclic structure, a substituent such as an alkyl group can be bonded.

Aliphatic diisocyanates having an intramolecular cyclic structure are desirably diisocyanate compounds having an alicyclic ring as the intramolecular cyclic structure (also referred to as “alicyclic diisocyanate compounds” below) from the perspectives of preventing yellowing and maintaining adequate elasticity and hardness in the molded article obtained. Compared to alicyclic diisocyanates, molded articles obtained from isocyanates having aromatic rings tend to yellow more, and molded articles obtained from aliphatic chain isocyanates tend to be soft and to have poor shape retention. Thus, alicyclic diisocyanates are desirably employed as component (B2) in the present invention.

Examples of alicyclic diisocyanates are: 4,4′-methylenebis(cyclohexylisocyanate), isophorone diisocyanate, 1,2-bis(isocyanatomethyl)cyclohexane, 1,3-bis(isocyanatomethyl)cyclohexane, 1,4-bis(isocyanatomethyl)cyclohexane, 1,2-diisocyanato cyclohexane, 1,3-diisocyanato cyclohexane, 1,4-diisocyanato cyclohexane, 2,5-bis(isocyanatomethyl)-1,4-dithiane, 2,3-bis(isocyanatomethyl)-1,4-dithiane, 2,6-bis(isocyanatomethyl)-1,4-dithiane, 2,4-bis(isocyanatomethyl)-1,3-dithiane, 2,5-bis(isocyanatomethyl)-1,3-dithiane, 4,6-bis(isocyanatomethyl)-1,3-dithiane, 4,5-bis(isocyanatomethyl)-1,3-dithiane, 2,5-diisocyanato-1,4-dithiane, 2,3-diisocyanato-1,4-dithiane, 2,6-diisocyanato-1,4-dithiane, 2,4-diisocyanato-1,3-dithiane, 2,5-diisocyanato-1,3-dithiane, 4,6-diisocyanato-1,3-dithiane, 4,5-diisocyanato-1,3-dithiane, 4,5-bis(isocyanatomethyl)-1,3-dithiolane, 4,5-diisocyanato-1,3-dithiolane, and 2,2-bis(isocyanatoethyl)-1,3-dithiane.

Examples of aliphatic diisocyanate compounds having an aromatic ring as the intramolecular cyclic structure are; m-xylylene diisocyanate, o-xylylene diisocyanate, p-xylylene diisocyanate, and m-tetramethylxylylene dilsocyanate.

Examples of aliphatic diisocyanate compounds having a heterocyclic ring as the intramolecular cyclic structure are 2,5-bis(isocyanatomethyl)thiophene and 3,4-bis(isocyanatomethyl)thiophene,

In particular, component (B2), from the perspectives of light resistance and weatherability, is desirably at least one compound selected from the group consisting of 4,4′-methylenebis(cyclohexylisocyanate), isophoron diisocyanate, 1,3-bis(isocyanatomethyl)cyclohexane, and 2,5-bis(isocyanatomethyl)-1,4-dithiane.

In the polymerization of transparent molded article 1 of the present invention, the ratio of NCO groups in component (B1) is preferably greater than or equal to 25 mole percent of the total NCO groups comprised in components (B1) and (B2). When this ratio is 25 mole percent or greater, a practically adequate degree of crosslinking can be achieved in polymerization, yielding a molded article with high heat resistance and good mechanical characteristics. From the perspectives of heat resistance, mechanical characteristics and the like, the ratio of NCO groups in component (B1) is more preferably greater than or equal to 35 mole percent of the total NCO groups comprised in components (B1) and (B2).

When polymerizing the monomer components comprising components (A) and (B1) to obtain transparent molded article 1, the molar ratio of isocyanate groups comprised in component (B1) preferably falls within a range of 1.00 to 1.15 relative to thiol groups comprised in component (A) from the perspective of obtaining a molded article of adequate toughness (strength), Further, when polymerizing the monomer components comprising components (A), (B1) and (B2), the molar ratio of isocyanate groups comprised in components (B1) and (B2) preferably falls within a range of 1.00 to 1.15 relative to thiol groups comprised in component (A) from the perspective of obtaining a molded article of adequate toughness (strength). In both cases, the above molar ratio more preferably ranges from 1.02 to 1.12.

When obtaining transparent molded article 1 of the present invention by polymerizing monomer components comprising components (A) and (B1), it is possible to employ, for example, the method of casting components (A) and (B1) into a casting mold and then heating components (A) and (B1) to polymerize them into a molded article, Further, when obtaining transparent molded article 1 of the present invention by polymerizing monomer components comprising components (A), (B1) and (B2), it is possible to employ, for example, the method of casting a mixture of components (A), (B1) and (B2) into a casting mold and then heating components (A), (B1) and (B2) to polymerize them into a molded article. The heating temperature in this process generally falls within a range of −20 to 160° C. The heating temperature need not be constant during polymerization, and can be varied in stepwise fashion. The heating time varies with conditions such as the heating temperature, and generally ranges frm 0.5 to 120 hours. In the polymerization of components (A), (B1) and (B2), a polymerization catalyst can be employed to improve polymerization properties. Specifically, an organic metal compound such as an organic tin compound, a tertiary arnine, or the like can be employed. The catalyst may be employed in a quantity of 0.001 to 1 mole percent relative to the isocyanate groups, for example.

Further, in transparent molded article 1 of the present invention, in addition to components (A), (B1) and (B2), various additives—such as ultraviolet radiation absorbing agents, coloring matter, pigments, and the like to improve light absorption characteristics; oxidation inhibitors, coloration inhibitors, and the like to improve weatherability; and plasticizers, mold releasing agents, and the like to improve molding properties—may be incorporated in suitable quantity so long as the nature of the transparent molded article is not compromised. These components may be mixed with the various components prior to polymerization, admixed during polymerization, or impregnated into the molded article obtained following polymerization.

Transparent molded article 1 of the present invention may be subjected to a surface treatment following molding, such as a hardcoat treatment to enhance scratch resistance or an antireflective coat treatment to reduce reflectance.

Transparent molded article 1 of the present invention may be a lens such as an eyeglass lens or an optical lens; a prism; optical fiber; a substrate for recording media employed in optical disks, magnetic disks, and the like; or an optical material such as a filter or the like. Preferably, transparent molded article 1 of the present invention is a lens, and more prefrably, an eyeglass lens.

[Second Aspect]

Transparent molded article 2 of the present invention is obtained by polymerizing monomer components comprising components (A), (B1), (B2) and (C).

Component (A), denoted by general formula (I) (wherein m is 1, 2, 3, 4, 5, or 6), is a polythiol compound with a 1,4-dithiane ring as its main skeleton. By incorporating this main skeleton, a high refractive index and a high Abbé number can be simultaneously imparted to the molded article obtained by polymerization without deteriorating weatherability.

Component (B1), denoted by general formula (II) (wherein n₁, n₂, and n₃ are each independently 3, 4, 5, 6, 7 or 8), is a polyisocyanate compound having a structure in which an isocyanate group is bonded through an alkylene group having 3 to 8 carbon atoms to an isocyanurate ring. With this compound serving as one of its starting materials, transparent molded article 2 of the present invention possesses a suitably crosslinked structure that imparts heat resistance and impact resistance that are highly balanced, as well as having good solvent resistance.

Component (B2) is one or more aliphatic diisocyanate compounds having an intramolecular cyclic structure. Including such a component (B2) in the monomer components yields a molded article with better heat resistance.

The details of components (A), (B1) and (B2) are identical to those described above for the first aspect.

Component (C) will be described below.

Component (C) is an aliphatic diol compound. In the present invention, an aliphatic diol compound is included in the monomer components to impart toughness to the molded article obtained without a reduction in weatherability or light resistance, Thus, in the present invention, a transparent molded article 2 is obtained that has good mechanical characteristics such as impact resistance.

To further enhance these mechanical characteristics, the aliphatic diol compound of component (C) preferably has a number average molecular weight ranging from 300 to 2,000. Toughness can be effectively imparted to the molded article when the number average molecular weight of the diol compound is greater than or equal to 300, and the hardness of the molded article can be maintained and its shape can hold readily when the number average molecular weight of the diol compound is less than or equal to 2,000. The number average molecular weight of the diol compound more preferably falls within a range of 600 to 1,500.

Examples of such diol compounds are polyetherdiol compounds such as polyethylene glycol, polypropylene glycol, and polytetramethylene glycol; polyesterdiol compounds such as polyesterdiol comprised of ethylene glycol and adipic acid, polyesterdiol comprised of propylene glycol and adipic acid, polyesterdiol comprised of diethylene glycol and adipic acid, polyesterdiol comprised of 1,4-butanediol and adipic acid, polyesterdiol comprised of neopentyl glycol and aipic acid, polyesterdiol comprised of 1,6-hexanediol and adipic acid, polyesterdiol comprised of 1,10-decanediol and adipic acid, polyesterdiol comprised of 1,4-butanediol and glutaric acid, polyesterdiol comprised of 1,4-butanediol and sebacic acid, polycaprolactonediol comprised of ethylene glycol and &caprolactone, polycaprolactonediol comprised of propylene glycol and ecaprolactone, polycaprolactonediol comprised of diethylene glycol and ε-caprolacone, polycaprolactonediol comprised of 1,4-butanediol and ε-caprolactone, polycaprolactonediol comprised of neopentyl glycol and ε-caprolactone, polycaprolactonediol comprised of 1,6-hexanediol and ε-caprolactone, and polycaprolactonediol comprised of 1,10-decanediol and ε-caprolactone; and polycarbonatediol compounds such as polycarbonate glycol. The above aliphatic diol compounds are preferably polyetherdiol compounds, which have good handling properties because of their lower viscosity at a given molecular weight, and further preferably polypropylene glycol, from the perspective of compatibility with other components. Such aliphatic diol compounds can be synthesized by known methods and are commercially available.

In the polymerization of transparent molded article 2 of the present invention, the mass ratio of component (C) relative to the total mass of components (A) and (C) preferably ranges from 3 to 60 percent, When this ratio is greater than or equal to 3 percent, toughness can be effectively imparted to the molded article obtained, and when it is less than or equal to 60 percent, adequate heat resistance and a high refractive index can be readily imparted to the molded article obtained. From the perspectives of the mechanical characteristics, heat resistance, optical characteristics, and the like of the molded article obtained, the mass ratio more preferably falls within a range of 8 to 40 percent.

In the second aspect of the present invention, in the polymerization of the above-stated monomer components, the ratio of NCO groups in component (B1) preferably falls within a range of 10 to 80 mole percent of the total NCO groups comprised in components (B1) and (B2). When this ratio is greater than or equal to 10 mole percent, a practically adequate degree of crosslinking can be achieved in polymerization, yielding a molded article having good heat resistance and mechanical characteristics. When this ratio is less than or equal to 80 mole percent, compatibility of components (B1) and (B2) with components (A) and (C) is high, yielding a molded article having a practically adequate transparency, From the perspectives of heat resistance, mechanical characteristics, transparency, and the like, in the polymerization of the monomer components, the ratio of NCO in component (B1) more preferably ranges from 15 to 65 mole percent of the total NCO groups comprised in components (B1) and (B2).

In the second aspect of the present invention, in the polymerization of the above-described monomer components, the molar ratio of isocyanate groups contained in components (B1) and (B2) relative to the total of thiol groups contained in component (A) and hydroxyl groups contained in component (C) preferably ranges from 1.00 to 1.15 from the perspective of yielding a molded article of adequate toughness (strength), This molar ratio more preferably ranges from 1.02 to 1.12.

When obtaining transparent molded article 2 of the present invention by polymerizing monomer components comprising components (A), (B1), (B2) and (C), for example, a method comprising casting a mixture of components (A), (B1), (B2) and (C) into a casting mold and then heating components (A), (B1), (B2) and (C) to polymerize them into a molded article may be employed. Herein, the mixture that is cast into a casting mold may be obtained by simply mixing components (A), (B1), (B2) and (C). Alternatively, components (C), (B1) and (B2) may be reacted in advance, as needed, using a urethane reaction catalyst such as a tertiary amine or an organic metal compound such as an organic tin compound for 5 to 50 minutes at 0 to 80° C. to form urethane bonds, and then component (A) is added to obtain a mixture. Still further, components (C) and (B1) may be reacted in advance, for example, under conditions identical to those set forth above to form urethane bonds and then components (B2) and (A) are added to obtain a mixture, or components (C) and (B2) may be reacted in advance, for example, under conditions identical to those set forth above to form urethane bonds, and then components (B1) and (A) are added to obtain a mixture.

The heating temperature when polymerizing the above mixture generally ranges from −20 to 160° C. for the cases described. This heating temperature does not have to be constant, and may be varied in stepwise fashion. The heating time varies with conditions such as the heating temperature, and generally ranges fom 0.5 to 120 hours. In the polymerization of the above mixture, a polymerization catalyst can be employed to improve polymerization properties in the cases described. Specifically, an organic metal compound such as an organic tin compound, a tertiary amine, or the like can be employed, The catalyst may be employed in a quantity of 0.001 to 1 mole percent relative to the isocyanate groups, for example.

Further, in transparent molded article 2 of the present invention, in addition to components (A), (B1), (B2) and (C), various additives—such as ultraviolet radiation absorbing agents, coloring matter, pigments, and the like to improve light absorption characteristics; oxidation inhibitors, coloration inhibitors, and the like to improve weatherability; and plasticizers, mold releasing agents, and the like to improve molding properties—may be incorporated in suitable quantity so long as the nature of the transparent molded article is not compromised. These components may be mixed with the various components prior to polymerization, admixed during polymerization, or impregnated into the molded article obtained following polymerization.

Transparent molded article 2 of the present invention may be subjected to a surface treatment following molding, such as a hardcoat treatnent to enhance scratch resistance or an antireflective coat treatment to reduce reflectance.

Transparent molded article 2 of the present invention may be a lens such as an eyeglass lens or an optical lens; a prism; optical fiber; a substrate for recording media employed in optical disks, magnetic disks, and the like; or an optical material such as a filter or the like. Preferably, transparent molded article 2 of the present invention is a lens, and more preferably, an eyeglass lens.

### EXAMPLES

Examples according to the embodiment of the present invention will be specifically described below.

Suitable modification of the materials, quantities employed, ratios, processing contents, and processing sequences described in Examples is possible without departing from the spirit of the present invention. Accordingly, the scope of the present invention must not be restrictively interpreted to the specific examples below.

The physical properties of the optical materials obtained were evaluated according to the following methods.

(1) Refractive Index (nD) and Abbé Number (vD)

These were measured at 20° C. with an Abbé Refractometer, Model 3T, made by Atago Co., Ltd.

(2) Coloration

The obtained lens was evaluated by visual observation. Those without coloration were rated as A, those with slight coloration (yellowing) as B, and those with marked coloration as C.

(3) Transparency

The obtained lens was evaluated by visual observation in a dark room under fluorescent lighting. Those in which no fogging or nontransparent matter precipitated out in the interior were rated as A. Those in which slight fogging and the like was observed were rated as B. And those in which severe fogging or the precipitation of nontransparent matter was clearly observed were rated as C. Lenses rated B or C were considered unsuitable for use as lenses.

(4) Optical Distortion

The obtained lens was evaluated by visual observation with the Schlieren method. Those without distortion were rated as A, those with only slight distortion along the edges as B, and those that were totally distorted as C.

(5) Impact Resistance

A test strip measuring 5 mm in width, 5 mm in depth, and 16 mm in height was prepared from the lens obtained and subjected to a fracture test at 20° C. using a Dynstat tester made by Toyo Seiki Seisaku-sho, Ltd. The energy required for fracture was calculated from the results and this value was adopted as a measure of the impact resistance: the greater the energy value, the greater the impact resistance.

[First Aspect]

### Example 1

A mixture of 0.29 mole of 2,5-bis(mercaptomethyl)-1,4-dithiane (denoted as “DMMD” in Table 1), 0.08 mole of tris(6-isocyanatohexyl)isocyanurate (denoted as “CX” in Table 1), 0.18 mole of 1,3-bis(isocyanatomethyl)cyclohexane (denoted as “HXDI” in Table 1), and 2.9×10⁻⁴ mole of dibutyl tin dilaurate (denoted as “DBTDL” in Table 1) was uniformly stirred, cast into a lens-forming glass mold, and hot polymerized for 10 hours at 50° C. followed by 5 hours at 60° C. and 3 hours at 120° C. to obtain a plastic lens. The various physical properties of the plastic lens obtained are given in Table 1. As indicated in Table 1, the lens of Example 1 had a high refractive index (nD) of 1.61, a high Abbé number (vD) of 40, no coloration, good transparency, and no optical distortion. It exhibited a fracture energy value of 120 (kg·cm/cm²), indicating good impact resistance.

### Examples 2 to 6

With the exception that the monomer compositions shown in Table 1 were employed, plastic lenses were obtained by the same operation as in Example 1. The various physical properties of these plastic lenses are given in Table 1. As indicated in Table 1, the plastic lenses of Examples 2 to 6 had high refractive indexes (nD) of 1.60 to 1.64, high Abbé numbers (vD) of 39 to 41, no coloration, good transparency, and no optical distortion. They exhibited fracture values of 90 to 120 kg·cm/cm², indicating good impact resistance.

### Comparative Example 1

A mixture of 0.20 mole of 4-mercaptomethyl-1,8-dimercapto-3,6-dithiaoctane (denoted as “MMMO” in Table 1), 0.30 mole of norbomene dilsocyanate (denoted as “NDI” in Table 1), and 3.0×10⁻⁴ mole of dibutyl tin dilaurate (denoted as “DBTDL” in Table 1) was uniformly mixed, cast into a lens-forming glass mold, and hot polymerized for 10 hours at 50° C. followed by 5 hours at 60° C. and 3 hours at 120° C. to obtain a plastic lens. The various physical properties of the plastic lens obtained are given in Table 1. As indicated in Table 1, the plastic lens of Comparative Example 1 had a high refractive index of 1.60, a high Abbé number of 41, no coloration, good transparency, and no optical distortion. However, it exhibited a fracture energy value of 35 kg·cm/cm², indicating low impact resistance.

### Comparative Examples 2 and 3

With the exception that the monomer compositions shown in Table 1 were employed, plastic lenses were obtained by the same operation as in Comparative Example 1. The various physical properties of these plastic lenses are given in Table 1. As indicated in Table 1, the plastic lens of Comparative Example 2 had a high refractive index of 1.62, no coloration, good transparency, and no optical distortion, but a somewhat low Abbé number of 38. Further, during evaluation of impact resistance, the impact resistance was so low that no fracture energy value could be calculated. The plastic lens of Comparative Example 3 had a high refractive index of 1,63, a high Abbé number of 40, no coloration, good transparency, and no optical distortion. However, It exhibited a fracture energy of 45 kg·cm/cm², indicating low impact resistance.

TABLE 1

| | | | | | | | | | Impact |
|---|---|---|---|---|---|---|---|---|---|
| | | Component (B) | | | | | | | resistance |
| | Component | Component | Component | Catalyst | | | | Optical | (fracture |
| Example | (A) (mol) | (B1) (mol) | (B2) (mol) | (mol) | nD/νD | Coloration | Transparency | distortion | energy) |
| 1 | DMMD(0.29) | CX(0.08) | HXDI(0.18) | DBTDL | 1.61/40 | A | A | A | 120 |
| | | | | (2.9 × 10⁻⁴) | | | | | kg cm/cm² |
| 2 | DMMD(0.28) | CX(0.13) | HXDI(0.10) | DBTDC | 1.60/41 | A | A | A | 100 |
| | | | | (2.8 × 10⁻⁴) | | | | | kg cm/cm² |
| 3 | DMMD(0.29) | CX(0.10) | BIMD(0.15) | DBTDL | 1.64/39 | A | A | A | 113 |
| | | | | (2.9 × 10⁻⁴) | | | | | kg cm/cm² |
| 4 | MMDDi(0.29) | CY(0.06) | HXDI(0.21) | DMTDC | 1.64/40 | A | A | A | 90 |
| | | | | (2.9 × 10⁻⁴) | | | | | kg cm/cm² |
| 5 | DMMD(0.25) | CX(0.18) | HXDI(0.03) | DMTDC | 1.60/41 | A | A | A | 102 |
| | MMDDi(0.04) | | | (2.9 × 10⁻⁴) | | | | | kg cm/cm² |
| 6 | MMDDi(0.29) | CX(0.20) | — | DMTDC | 1.62/41 | A | A | A | 95 |
| | | | | (2.9 × 10⁻⁴) | | | | | kg cm/cm² |

| | | | | | | | | | Impact |
|---|---|---|---|---|---|---|---|---|---|
| | | Component (B) | | | | | | | resistance |
| | Component | Component | Component | Catalyst | | | | Optical | (fracture |
| Comp. Ex. | (A) (mol) | (B1) (mol) | (B2) (mol) | (mol) | nD/νD | Appearance | Transparency | distortion | energy) |
| 1 | MMMO(0.20) | — | NDI(0.03) | DBTDL | 1.60/41 | A | A | A | 35 |
| | | | | (3.0 × 10⁻⁴) | | | | | kg cm/cm² |
| 2 | DMMD(0.29) | — | HXDI(0.30) | DBTDL | 1.62/38 | A | A | A | Too low |
| | | | | (2.9 × 10⁻⁴) | | | | | to be |
| | | | | | | | | | evaluated. |
| 3 | DMMD(0.29) | LTI(0.08) | HXDI(0.18) | DBTDL | 1.63/40 | A | A | A | 45 |
| | | | | (2.9 × 10⁻⁴) | | | | | kg cm/cm² |

Compound names denoted by an abbreviation in Table 1 are as follows:
DMMD: 2,5-bis(mercaptomethyl)-1,4-dithiane,
MMDDi: disulfide dimer of 2,5-bis(mercaptomethyl)-1,4-dithiane,
CX: tris(6-isocyanatohexyl)isocyanurate,
CY: tris(4-isocyanatobutyl)isocyanurate,
HXDI: 1,3-bis(isocyanatomethyl)cyclohexane,
BIMD: 2,5-bis(isocyanatomethyl)-1,4-dithiane,
DBTDL: di-n-butyl tin dilaurate,
DBTDC: di-n-butyl tin dichloride,
MMMO: 4-mercaptomethyl-1,8-dimercapto-3,6-dithiaoctane,
NDI: norbornene diisocyanate,
LTI: lysine triisocyanate.

Second Aspect]

### Example 7

A mixture of 0.04 mole of polypropylene glycol with a number average molecular weight of 1,000 (component (C), denoted in Table 2 as “P1000”), 0.11 mole of tris(6-isocyanatohexyl)isocyanurate (component (B1), denoted in Table 2 as “CX”), 0.65 mole of 1,3-bis(isocyanatomethyl)cyclohexane (component (B2), denoted in Table 2 as “HXDI”), and 0.4×10⁻⁴ mole of dibutyl tin dilaurate (denoted in Table 2 as “DBTDL”) was reacted while being uniformly stirred for two hours at 40° C. Subsequently, 0.75 mole of 2,5-bis(mercaptomethyl)-1,4-dithiane (component (A), denoted in Table 2 as “DMMD”) and 7.5×10⁻⁴ mole of DBTDL were added and uniformly stirred. The mixture was then cast into a lens-forming glass.mold and hot polymerized for 10 hours at 50° C. followed by 5 hours at 60° C. and 3 hours at 120° C., yielding a plastic lens. The various physical properties of the plastic lens obtained are given in Table 2. As indicated in Table 2, the lens of Example 7 had a high refractive index (nD) of 1.61, a high Abbé number (vD) of 41, no coloration, good transparency, and no optical distortion. It exhibited a fracture energy value of 155 kg·cm/cm², indicating good impact resistance.

### Examples 8 to 12

With the exception that the monomer components shown in Table 2 were employed, plastic lenses were obtained by the same operation as in Example 7. The various physical properties of these plastic lenses are given in Table 2 along with the various physical properties of the plastic lens of Example 7. As indicated in Table 2, the plastic lenses of Examples 8 to 12 had high refractive indexes (nD) of 1.60 to 1.64, high Abbé numbers (vD) of 39 to 42, no coloration, good transparency, and no optical distortion. They exhibited fracture energy values of 135 to 160 kg·cm/cm², indicating good impact resistance.

### Example 13

A mixture of 0.60 mole of 2,5-bis(mercaptomethyl)-1,4-dithiane (component (A), denoted in Table 2 as “DMMD”), 0.02 mole of polypropylene glycol having a number average molecular weight of 700 (component (C), denoted in Table 2 as “P700”), 0.18 mole of tris(6-isocyanatohexyl)isocyanurate (component (B1), denoted in Table 2 as “CX”), 0.38 mole of 1,3-bis(isocyanatomethyl)cyclohexane (component (B2), denoted in Table 2 as “HXDI”), and 6.2×10⁻⁴ mole of dibutyl tin dichloride (denoted as “DBTDC” in Table 2) was uniformly stirred, cast into a lens-forming glass mold, and hot polymerized for 10 hours at 50° C. followed by 5 hours at 60° C. and three hours at 120° C. to obtain a plastic lens. The various physical properties of the plastic lens obtained are given in Table 2. As indicated in Table 2, the lens of Example 13 had a high refractive index (nD) of 1.60, a high Abbé number (vD) of 40, no coloration, good transparency, and no optical distortion. It exhibited a fracture energy value of 131 kg·cm/cm², indicating good impact resistance.

As apparent from the results of Examples 7 to 13, the present invention provides lenses having excellent characteristics, such as refractive indexes of 1.60 or higher, Abbé numbers of 39 or higher, good transparency, and no coloration and optical distortion, and exhibiting fracture energy values of greater than or equal to 130 kg·cm/cm², thus having good impact resistance.

### Comparative Example 4

A mixture of 0.20 mole of 4-mercaptomethyl-1,8-dimercapto-3,6-dithiaoctane (denoted as “MMMO” in Table 2), 0.30 mole of norbomene diisocyanate (denoted as “NDI” in Table 2), and 3.0×10⁻⁴ mole of dibutyl tin dilaurate (denoted as “DBTDL” in Table 2) was uniformly stirred, cast into a lens-forming glass mold, and hot polymerized for 10 hours at 50° C. followed by 5 hours at 60° C. and 3 hours at 120° C. to obtain a plastic lens. The various physical properties of the plastic lens obtained are given in Table 2. As indicated in Table 2, the plastic lens of Comparative Example 4 had a high refractive index of 1.60, a high Abbé number of 41, no coloration, good transparency, and no optical distortion. However, it exhibited a fracture energy value of 35 kg·cm/cm², indicating low impact resistance.

### Comparative Examples 5 and 6, Reference Example 1

With the exception that the monomer compositions shown in Table 2 were employed, plastic lenses were obtained by the same operation as in Comparative Example 4. The various physical properties of these plastic lenses are given in Table 2 along with the various physical properties of the lenses of Examples 7 to 13 and Comparative Example 4. The plastic lens of Comparative Example 5 was obtained by polymerization of the monomer components for obtaining transparent molded article 2 of the present invention without components (C) and (B1). As indicated in Table 2, the lens of Comparative Example 5 had a high refractive index of 1.62, no coloration, good transparency, and no optical distortion, but a somewhat low Abbé number of 38. Further, during evaluation of impact resistance, the impact resistance was so low that no fracture energy value could be calculated.

As indicated in Table 2, the plastic lens of Comparative Example 6 had a high refractive index of 1.63, a high Abbé number of 41, no coloration, good transparency, and no optical distortion. However, it exhibited a fracture energy of 45 kg·cm/cm², indicating low impact resistance.

The plastic lens of Reference Example 1 was obtained by polymerizing the monomer components for obtaining transparent molded article 2 of the present invention without component (C). As indicated in Table 2, the lens of Reference Example 1 had a high refractive index of 1.61, a high Abbé number of 40, no coloration, good transparency, and no optical distortion. It exhibited a fracture energy value of 120 kg·cm/cm², thus having impact resistance that was greater than the lens of Comparative Example 5 not comprising component (B1), but poorer than transparent molded article 2 of the present invention containing component (C).

TABLE 2

| | | | | | | Ratio of component |
|---|---|---|---|---|---|---|
| | | | | | | (C) relative to the |
| | | | | | | total of components |
| | Component | Component | Component | Component | Catalyst | (A) and (C) |
| | (A) (mol) | (B1) (mol) | (B2) (mol) | (C) (mol) | (mol) | (weight percent) |
| Example | | | | | | |
| 7 | DMMD(0.75) | CX(0.11) | HXDI(0.65) | P1000(0.04) | DBTDL | 20.0 |
| | | | | | (7.9 × 10⁻⁴) | |
| 8 | DMMD(0.62) | CX(0.18) | BIMD(0.43) | P1000(0.06) | DBTDL | 31.3 |
| | | | | | (6.8 × 10⁻⁴) | |
| 9 | DMMD(0.36) | CY(0.06) | BIMD(0.38) | P1000(0.08) | DMTDC | 51.2 |
| | | | | | (4.4 × 10⁻⁴) | |
| 10 | DMMD(0.56) | CX(0.24) | BIMD(0.36) | P700(0.05) | DMTDC | 18.7 |
| | MMDDi(0.08) | | | | (6.9 × 10⁻⁴) | |
| 11 | DMMD(0.42) | CX(0.06) | HXDI(0.36) | P1200(0.02) | DMTDC | 21.2 |
| | | | | | (4.4 × 10⁻⁴) | |
| 12 | DMMD(0.44) | CX(0.06) | BIMD(0.44) | PBG(0.06) | DMTDC | 39.1 |
| | | | | | (5.0 × 10⁻⁴) | |
| 13 | DMMD(0.60) | CX(0.18) | HXDI(0.38) | P700(0.02) | DBTDC | 9.9 |
| | | | | | (6.2 × 10⁻⁴) | |
| Comp. Ex. | | | | | | |
| 4 | MMMO(0.20) | — | NDI(0.30) | — | DBTDL | — |
| | | | | | (3.0 × 10⁻⁴) | |
| 5 | DMMD(0.29) | — | HXDI(0.30) | — | DBTDL | 0.0 |
| | | | | | (2.9 × 10⁻⁴) | |
| 6 | DMMD(0.29) | LTI(0.08) | HXDI(0.18) | — | DBTDL | — |
| | | | | | (2.9 × 10⁻⁴) | |
| Reference | | | | | | |
| Ex. | | | | | | |
| 1 | DMMD(0.29) | CX(0.08) | HXDI(0.18) | — | DBTDL | 0.0 |
| | | | | | (2.9 × 10⁻⁴) | |

| | | | | Optical | Impact resistance |
|---|---|---|---|---|---|
| Example | nD/νD | Coloration | Transparency | distortion | (fracture energy) |
| 7 | 1.61/41 | A | A | A | 155 kg · cm/cm² |
| 8 | 1.62/40 | A | A | A | 145 kg · cm/cm² |
| 9 | 1.60/42 | A | A | A | 140 kg · cm/cm² |
| 10 | 1.64/41 | A | A | A | 135 kg · cm/cm² |
| 11 | 1.61/40 | A | A | A | 160 kg · cm/cm² |
| 12 | 1.62/39 | A | A | A | 142 kg · cm/cm² |
| 13 | 1.60/40 | A | A | A | 131 kg · cm/cm² |

| | | | | Optical | Impact resistance |
|---|---|---|---|---|---|
| | nD/νD | Appearance | Transparency | distortion | (fracture energy) |
| Comp. Ex. | | | | | |
| 4 | 1.60/41 | A | A | A | 35 kg · cm/cm² |
| 5 | 1.62/38 | A | A | A | Too low to be |
| | | | | | evaluated |
| 6 | 1.63/40 | A | A | A | 45 kg · cm/cm² |
| Reference | | | | | |
| Ex. | | | | | |
| 1 | 1.61/40 | A | A | A | 120 kg · cm/cm² |

Compound names denoted by an abbreviation in Table 2 are as follows:
DMMD: 2,5-bis(mercaptomethyl)-1,4-dithiane,
MMDDi: disulfide dimer of 2,5-bis(mercaptomethyl)-1,4-dithiane,
P1000: polyproplylene glycol having a number average molecular weight of 1000,
P700: polypropylene glycol having a number average molecular weight of 700,
P1200: polypropylene glycol having a number average molecular weight of 1200,
PBG: polyesterdiol comprised of 1,4-butanediol and glutaric acid and having a number average molecular weight of 1000,
CX: tris(6-isocyanatohexyl)isocyanurate,
CY: tris(4-isocyanatobutyl)isocyanurate,
HXDI: 1,3-bis(isocyanatomethyl)cyclohexane,
BIMD: 2,5-bis(isocyanatomethyl)-1,4-dithiane,
DBTDL: di-n-butyl tin dilaurate,
DBTDC: di-n-butyl tin dichloride,
MMMO: 4-mercaptomethyl-1,8-dimercapto-3,6-dithiaoctane,
PETMP: pentaerythritoltetrakis(3-mercaptoproprionate),
NDI: norbornene diisocyanate,
LTI: lysine triisocyanate.

Compound names denoted by an abbreviation in Table 2 are as follows: DMMD: 2,5-bis(mercaptomethyl)-1,4-dithiane, MMDDi: disulfide dimer of 2,5-bis(mercaptomethyl)-1,4-dithiane, P1000: polypropylene glycol having a number average molecular weight of 1000, P700: polypropylene glycol having a number average molecular weight of 700, P 1200: polypropylene glycol having a number average molecular weight of 1200, PBG: polyesterdiol comprised of 1,4-butanediol and glutaric acid and having a number average molecular weight of 1000, CX: tris(6-isocyanatohexyl)isocyanurate, CY: tris(4-isocyanatobutyl)isocyanurate, HXDI: 1,3-bis(isocyanatomethyl)cyclohexane, BIMD: 2,5-bis(isocyanatomethyl)-1,4-dithiane, DBTDL: di-n-butyl tin dilaurate, DBTDC: di-n-butyl tin dichloride, MMMO: 4-mercaptomethyl-1,8-dimercapto-3,6-dithiaoctane, PETMP: pentaerythritoltetrakis(3-mercaptopropionate), NDI: norbornene diisocyanate, LTI: lysine triisocyanate.

The transparent molded article 1 of the present invention has characteristics such as excellent refractive index, Abbé number, weatherability, solvent resistance and transparency as well as no optical distortion. In particular, it is characterized by excellent impact resistance. Accordingly, the transparent molded article 1 of the present invention can be suitably employed for optical lenses such as an eyeglass lens and camera lens, and the like.

According to the second aspect of the present invention, the transparent molded article 2 suitable for optical applications can be provided, that has a refractive index and transparency equal to or higher than those of molded articles conventionally employed in optical materials such as lenses as well as has higher impact strength than that of molded articles conventionally employed in optical materials such as lenses. Furthermore, the transparent molded article 2 of the present invention has excellent characteristics such as high Abbé number, excellent weatherability and solvent resistance as well as no optical distortion. The transparent molded article 2 of the present invention can be suitably employed for various lenses such as an eyeglass lens and camera lens, a prism, optical fiber, a substrate for recording media, a filter and the like.

What is claimed is:

1. A transparent molded article comprised of polythiouredtane obtained by polymerizing monomer components comprising the following component (A) and component (B1).
Component (A): one or more polythiol compound denoted by general formula (I)
General formula (I) 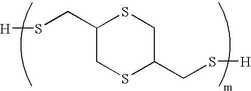
(In general formula (I), m is 1, 2, 3, 4, 5 or 6.)
Component (B1): one or more polyisocyanate compound denoted by general formula (II)
General formula (II) 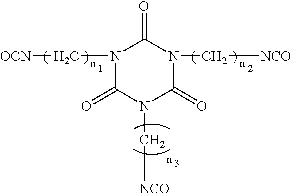
(In general formula (II), n₁, n₂ and n₃ arm each independently 3, 4, 5, 6, 7 or 8.)

2. The transparent molded article according to claim 1, wherein said monomer components further comprises the following component (B2). Component (B2): one or more aliphatic diisocyanate compound having an intramolecular cyclic structure.

3. The transparent molded article according to claim 2, wherein, in said polymerization, the ratio of NCO groups in component (B1) is greater than or equal to 25 mole percent of the total NCO groups comprised in component (B1) and component (B2).

4. The transparent molded article according to claim 1, wherein, in general formula (I) of component (A), m is 1 or 2.

5. The transparent molded article according to claim 1, wherein, in general formula (II) of component (B1), n₁, n₂ and n₃ are each independently 4, 5 or 6.

6. The transparent molded article according to claim 1, wherein, in said polymerization, the molar ratio of isocyanate groups comprised in component (B1) and component (B2) relative to thiol groups comprised in component (A) ranges from 1.00 to 1.15.

7. The transparent molded article according to claim 1, wherein the transparent molded article is a lens.

8. The transparent molded article according to claim 7, wherein the lens is an eyeglass lens.

9. A transparent molded article obtained by polymerizing monomer components comprising the following component (A), component (B1), component (B2) and component (C).
Component (A): one or more polythiol compound denoted by general formula (I)
General formula (I) 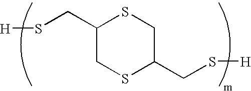
(In general formula (I), m is 1, 2, 3, 4, 5 or 6.)
Component (B1): one or more polyisocyanate compound denoted by general formula (II)
General formula (II) 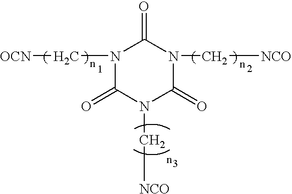
(In general formula (II), n₁, n₂ and n₃ are each independently 3, 4, 5, 6, 7 or 8.)
Component (B2): one or more aliphatic diisocyanate compound having an intramolecular cyclic structure
Component (C): aliphatic diol compound

10. The transparent molded article according to claim 9, wherein, in said monomer components, the mass ratio of component (C) relative to total mass of component (A) and component (C) ranges from 3 to 60 percent.

11. The transparent molded article according to claim 9, wherein, in said polymerization, the ratio of NCO groups in component (B1) ranges from 10 to 80 mole percent of the total NCO groups comprised in component (B1) and component (B2).

12. The transparent molded article according to claim 9, wherein, in general formula (I) of component (A), m is 1 or 2.

13. The transparent molded article according to claim 9, wherein said component (C) has a number average molecular weight ranging from 300 to 2000.

14. The transparent molded article according to claim 13, wherein said component (C) has a number average molecular weight ranging from 600 to 1500.

15. The transparent molded article according to claim 9, wherein the aliphatic diol compound of component (C) is polyetherdiol compound.

16. The transparent molded article according to claim 15, wherein said polyetherdiol compound is polypropylene glycol.

17. The transparent molded article according to claim 9, wherein, in general formula (II) of said component (B1), n₁, n₂ and n₃ are each independently 4, 5 or 6.

18. The transparent molded article according to claim 9, wherein, in said polymerization, the molar ratio of isocyanate groups comprised in component (B1) and component (B2) relative to the total of thiol groups comprised in component (A) and hydroxyl groups comprised in component (C) ranges from 1.00 to 1.15.

19. The transparent molded article according to claim 9, wherein the transparent molded article is a lens.

20. The transparent molded article according to claim 19, wherein the lens is an eyeglass lens.
